(19) United States
(12) Patent Application Publication
(10) Pub. No.: US 2009/0055384 A1
(43) Pub. Date: Feb. 26, 2009

(54) SHARED INFLUENCE SEARCH

(75) Inventors: Gaurav Jain, Santa Clara, CA (US); Erik Steffl, Brisbane, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/844,253

(22) Filed: Aug. 23, 2007

(51) Int. Cl. G06F 17/30

(52) U.S. Cl. 707/5; 707/E17.017

(57) ABSTRACT

In one embodiment, a search query is received from a user. Then a designated expert for the search query is determined. Search results based at least in part upon previous actions taken by the expert relevant to the search query are then identified. These results may then be returned to the user.

### BACKGROUND OF THE INVENTION

1. Field of the Invention

The present invention relates to conducting searches for electronic documents such as web pages. More particularly, the present invention relates to a shared influence search.

2. Description of the Related Art

Searching for documents such as web sites using a search engine typically produces a set of search results based upon a “group think” mentality of attempting to provide search results that the majority of users will find useful, as viewed by the search engine administrators. Such a system tends to produce inaccurate or incomplete results for some users as well as some types of searches (e.g., searches on niche topics or topics with keywords that can span across many different topics).

### SUMMARY OF THE INVENTION

In one embodiment, a search query is received from a user. Then a designated expert for the search query is determined. Search results based at least in part upon previous actions taken by the expert relevant to the search query are then identified. These results may then be returned to the user.

### BRIEF DESCRIPTION OF THE DRAWINGS

FIG. 1 is a diagram illustrating a method in accordance with an embodiment of the present invention.

FIG. 2 is a diagram illustrating a method in accordance with an embodiment of the present invention.

FIG. 3 is an exemplary network diagram illustrating some of the platforms that may be employed with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

According to various embodiments of the present invention, users are given more control over search results. This allows users to more readily find information that they are looking for as opposed to being forced to see what the search engine thinks is important.

In one embodiment of the present invention, users may select other users as “experts.” In this context, being selected as an “expert” means that another user finds the expert to produce particularly relevant search results. This can be particularly helpful in particular subject matters in which the user needs precise searching. For example, a user may need to commonly search on various computing topics for his job as a computer programmer. Using an embodiment of the present invention, the user may select other users as experts in searching on computer topics. Therefore, whenever the user searches for a computing topic, the search engine may user prior searches and/or actions by the selected expert (or experts) in determining which results to display to the user, in addition to or in lieu of the results that the search engine would typically provide without input from experts.

Selecting another user as an expert may occur in various different ways. First, the user may actually know the potential expert. For example, the user may have a family member, work colleague, or friend that the user knows is particularly adept at searching on a particular topic. Second, the user may find a potential expert through a reputation network. A reputation network may be any network that provides a listing or ranking of potential experts. For example, the search engine may provide a web site that lists potential experts in various fields. The potential experts may be ranked based on user feedback on, for example, the quality of their previous searches.

The information collected from experts and subsequently used to influence subsequent search results by other users as well as used to rank the potential experts may include the search terms applied, search results returned that were subsequently clicked on, and/or any search results that were explicitly “bookmarked” or otherwise identified as a search result of interest.

The expert selection process may also be automated, either entirely or in part. For example, the user may on the one hand explicitly pick a particular expert. Alternatively, the user may select a group of potential experts and the search engine may narrow this group down to an acceptable number. In another embodiment, the system may assign an expert for a particular user or search based on various factors, including, for example, the user's current search terms, the user's search history, the user's profile (e.g., identified hobbies), user demographics, and/or the user's geographic location.

The expert's previous searches may influence the search results of any user who selects the expert to be an expert on any particular topic. This influence may occur in many different ways. For example, higher weightings may be applied to search results of an identified expert than those that would normally be produced by the search engine. The results of both, however, may be presented together in a seamless manner. Alternatively, results produced due to the expert's influence on the search may be presented separately or marked as being “expert picks.” The latter embodiments then allow for the possibility that users can subsequently rank the expert's picks (e.g., the value of the link to the user, on a scale of 1 to 10), resulting in a dynamic process wherein experts are not only selected based on past performance but are also being constantly reevaluated based on current performance.

In another embodiment of the present invention, the search engine may not only present results based on the expert's influence, but may also present the search terms that the expert used that produced the expert's picks. This allows the user to learn how the expert managed to get such good search results so that the user may improve his or her own searching ability.

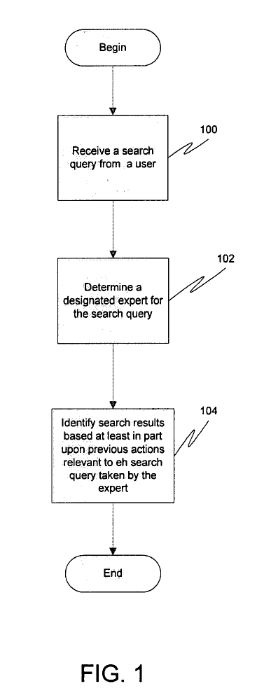

FIG. 1 is a flow diagram illustrating a method in accordance with an embodiment of the present invention. At 100, a search query is received from a user. At 102, a designated expert for the search query is determined. This determination may include identifying a search category for the search query and locating an expert selected by the user for the search category. The expert may have been selected for the user for a particular search category. This selection may include receiving a group of potential experts from the user and automatically selecting one or more experts from the group. Alternatively, the selecting may include assigning an expert to the user for a particular search category based on one or more factors selected from the group consisting of: user search terms, user search history, user profile, user demographics, and user geographic location. In another embodiment, the selection of the expert may be received from the user. At 104, search results based at least in part upon previous actions taken by the expert relevant to the search query are identified. These results may then be returned to the user.

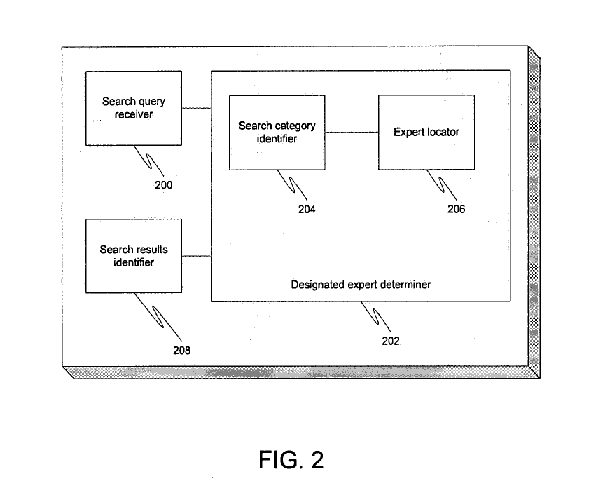

As will be understood, each of the processes depicted in FIG. 1 may be performed by a module of software operating on a server having an interface and executed by a processor. FIG. 2 is a block diagram illustrating an apparatus in accordance with an embodiment of the present invention. The apparatus may include a search query receiver 200 that receives the search query from a user. A designated expert determiner 202 coupled to the search query receiver 200 may determine a designated expert for the search query. This determination may include identifying a search category for the search query using a search category identifier 204 and locating an expert selected by the user for the search category using an expert locator 206 coupled to the search category identifier 204. The expert may have been selected for the user for a particular search category. This selection may include receiving a group of potential experts from the user and automatically selecting one or more experts from the group. Alternatively, the selecting may include assigning an expert to the user for a particular search category based on one or more factors selected from the group consisting of: user search terms, user search history, user profile, user demographics, and user geographic location. In another embodiment, the selection of the expert may be received from the user. A search results identifier 208 coupled to the designated expert determiner 202 may identify search results based at least in part upon previous actions taken by the expert relevant to the search query.

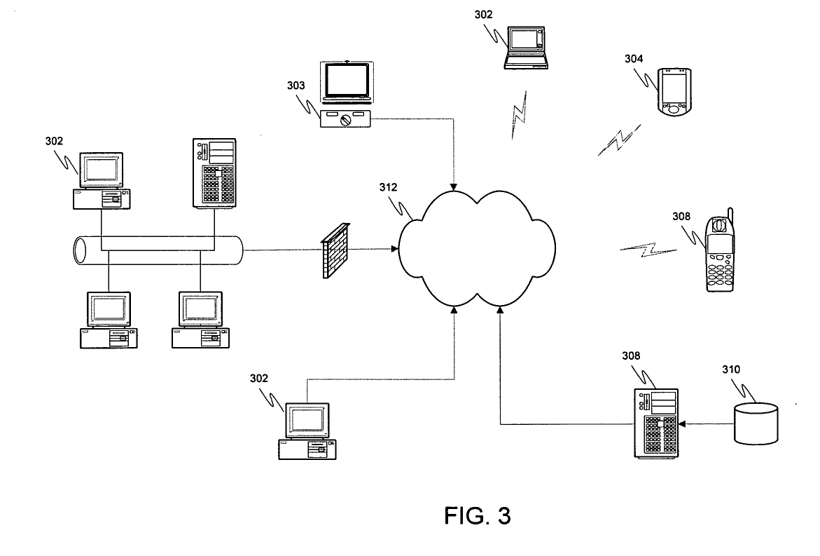

It should also be noted that embodiments of the present invention may be implemented on any computing platform and in any network topology in which presentation of search results is a useful functionality. For example and as illustrated in FIG. 3, implementations are contemplated in which the invention is implemented in a network containing personal computers 302, media computing platforms 303 (e.g., cable and satellite set top boxes with navigation and recording capabilities (e.g., Tivo)), handheld computing devices (e.g., PDAs) 304, cell phones 306, or any other type of portable communication platform. Users of these devices may navigate the network, and this information may be collected by server 308. Server 308 (or any of a variety of computing platforms) may include a memory, a processor, and a communications component and may then utilize the various techniques described above. The processor of the server 308 may be configured to run, for example, all of the processes described in FIG. 1. Server 308 may be coupled to a database 310, which stores information relating to experts. Applications may be resident on such devices, e.g., as part of a browser or other application, or be served up from a remote site, e.g., in a Web page (also represented by server 308 and database 310). The invention may also be practiced in a wide variety of network environments (represented by network 312), e.g., TCP/IP-based networks, telecommunications networks, wireless networks, etc. The invention may also be tangibly embodied in one or more program storage devices as a series of instructions readable by a computer (i.e., in a computer readable medium).

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method comprising:
receiving a search query from a user;
determining a designated expert for the search query; and
identifying search results based at least in part upon previous actions taken by the expert relevant to the search query.

2. The method of claim 1, wherein the determining includes:
identifying a search category for the search query; and
locating an expert selected by the user for the search category.

3. The method of claim 1, further comprising selecting an expert for the user for a particular search category.

4. The method of claim 3, wherein the selecting includes receiving a selected expert from the user.

5. The method of claim 3, wherein the selecting includes receiving a group of potential experts from the user and automatically selecting one or more experts from the group.

6. The method of claim 3, wherein the selecting includes assigning an expert to the user for a particular search category based on one or more factors selected from the group consisting of: user search history, user profile, user demographics, and user geographic location.

7. An apparatus comprising:
a search query receiver;
a designated expert determiner coupled to the search query receiver; and
a search results identifier coupled to the designated expert determiner.

8. The apparatus of claim 7, wherein the designated expert determiner includes:
a search category identifier; and
an expert locator coupled to the search category identifier.

9. An apparatus comprising:
means for receiving a search query from a user;
means for determining a designated expert for the search query; and
means for identifying search results based at least in part upon previous actions taken by the expert relevant to the search query.

10. The apparatus of claim 9, wherein the means for determining includes:
means for identifying a search category for the search query; and
means for locating an expert selected by the user for the search category.

11. The apparatus of claim 9, further comprising means for selecting an expert for the user for a particular search category.

12. The apparatus of claim 11, wherein the means for selecting includes means for receiving a selected expert from the user.

13. The apparatus of claim 11, wherein the means for selecting includes means for receiving a group of potential experts from the user and automatically selecting one or more experts from the group.

14. The apparatus of claim 11, wherein the means for selecting includes means for assigning an expert to the user for a particular search category based on one or more factors selected from the group consisting of: user search history, user profile, user demographics, and user geographic location.

15. A program storage device readable by a machine tangibly embodying a program of instructions executable by the machine to perform a method comprising:
receiving a search query from a user;
determining a designated expert for the search query; and
identifying search results based at least in part upon previous actions taken by the expert relevant to the search query.

16. The program storage device method of claim 15, wherein the determining includes:
identifying a search category for the search query; and
locating an expert selected by the user for the search category.

17. The program storage device of claim 15, wherein the method further comprises selecting an expert for the user for a particular search category.

18. The program storage device of claim 17, wherein the selecting includes receiving a selected expert from the user.

19. The program storage device of claim 17, wherein the selecting includes receiving a group of potential experts from the user and automatically selecting one or more experts from the group.

20. The program storage device of claim 17, wherein the selecting includes assigning an expert to the user for a particular search category based on one or more factors selected from the group consisting of: user search history, user profile, user demographics, and user geographic location.
